(19) United States
(12) Patent Application Publication
(10) Pub. No.: US 2010/0096369 A1
(43) Pub. Date: Apr. 22, 2010

(54) Multi-axis laser welding head for spacer grid

(75) Inventors: Byeong-Eun Oh, Daejeon (KR); Hak-beum Park, Daejeon (KR); Yong-kwan Kim, Daejeon (KR); Myoung-ho Oh, Daejeon (KR); Hung-soon Chang, Daejeon (KR); Sang-hyun Lim, Daejeon (KR)

Correspondence Address: SUGHRUE MION, PLLC, 2100 PENNSYLVANIA AVENUE, N.W., SUITE 800, WASHINGTON, DC, 20037, US

(73) Assignee: Korea Nuclear Fuel Co., Ltd., Daejeon (KR)

(21) Appl. No.: 11/971,012

(22) Filed: Jan. 8, 2008

(30) Foreign Application Priority Data
Sep. 28, 2007 (KR) 10-2007-0098255

(51) Int. Cl. B23K 26/00

(52) U.S. Cl. 219/121.63

(57) ABSTRACT

Disclosed therein is a multi-axis laser welding head for a spacer grid, which is one of essential components of a nuclear fuel assembly. More particularly, the multi-axis laser welding head for the spacer grid can be operated more smoothly and variously during the welding of the spacer grid to thereby weld the spacer grid more exactly and precisely. For this, the multi-axis laser welding head includes a welding head having a movement within a predetermined angle like the back and forth swing of the pendulum, and can irradiate a laser beam in various directions by having additional axis in comparison with the prior art.

### BACKGROUND OF THE INVENTION

1. Field of the Invention

The present invention relates to a multi-axis laser welding head for a spacer grid, which is one of essential components of a nuclear fuel assembly, and more particularly, to a multi-axis laser welding head for a spacer grid, which can be operated more smoothly and variously during the welding of the spacer grid, thereby welding the spacer grid more exactly and precisely.

2. Background Art

A nuclear reactor refers to a device which is designed to be used for various purposes such as for instance, artificially controlling a fission chain reaction of a fissile material to generate heat, produce radioactive isotopes and Plutonium, form a radiation field, and the like.

In general, a light water reactor employs enriched uranium, in which a ratio of uranium-235 is raised to 2% to 5%. In order to process the enriched uranium into a nuclear fuel used in the nuclear reactor, a forming process of forming uranium into cylindrical pellets of about 5 g is required. The pellets are charged into a zircaloy cladding tube, a spring and helium gas are put into the zircaloy cladding tube, and then, an endcap is welded onto the zircaloy cladding tube to thereby manufacture a fuel rod. The fuel rod is inserted into a skeleton to thereby finally form a nuclear fuel assembly, so that the fuel rod is burned in the nuclear reactor through a nuclear reaction.

A general shape of the nuclear fuel assembly is illustrated in FIG. 1.

Referring to FIG. 1, the nuclear fuel assembly includes: a skeleton having a top stationary 4, a bottom stationary 5, a spacer grid 2, a guide tube 3, and a metering tube 6; and a fuel rod 1 inserted into the spacer grid 2 and supported by a spring (not shown) and a dimple (not shown) formed in the spacer grid 2. When the fuel assembly is assembled, to prevent a scratch on the surface of the fuel rod 1 and prevent a damage of the spring disposed in the spacer grid, the surface of the fuel rod is coated with lacquer, and then, the fuel rod is inserted into the skeleton. Next, the top skeleton 4 and the bottom skeleton 5 are bonded and fixed to the skeleton to thereby finish assembling of the fuel assembly. When the fuel assembly is completely assembled, after lacquer coated on the fuel assembly is removed, an interval, distortion, the total length, and dimensions of the fuel rod are tested, so that a fuel assembly manufacturing process is finished.

The spacer grid contained in the nuclear fuel assembly constitutes the skeleton together with the fuel rod, the metering tube and the guide tube, and is formed by several tens of grid plates. Each grid plate has a number of slots. The grid plates are spaced apart from each other at fixed intervals in vertical and horizontal directions, so that the grid plates are crossed with each other. The slots of the grid plates are forcedly fit to other slots of other grid plates to thereby form the spacer grid.

However, even though the slots of the grid plates are forced fit to other slots of other grid plates, since there are gaps between the slots, the spacer grid may shake. So, each intersection where the grid plates are crossed with each other is welded to prevent shaking of the spacer grid. A method for welding the spacer grid, a laser welding has been used the most.

As shown in FIG. 2, for the laser welding, a rectangular retention strap 10, which has the same width as the spacer grid, is fit to the central portions of four external sides of the assembled spacer grid. The reason is to prevent a change in shape of the assembled spacer grid before welding since the spacer grid assembled through the slots of the grid plates is changed in its shape due to a shake generated by the gaps of the intersections between the slots.

A top plate 20 and a bottom plate 30 of a rectangular plate type are fit to the top and bottom of the spacer grid, to which the retention strap 10 is fit, in parallel with the retention strap 10. The top plate 20 and the bottom plate 30 respectively have a number of through holes 22 formed at positions corresponding to the intersections of the vertical and horizontal grid plates of the spacer grid. The intersections of the vertical and horizontal grid plates of the spacer grid are welded by shooting a laser beam to the through holes 22.

In addition, the rectangular top plate 20 has top plate fixing holes 24 formed at central portions of two opposite sides thereof. Also, the bottom plate 30 has bottom plate fixing holes 34 of the same form as the top plate fixing holes 24 at central portions of two opposite sides thereof.

The top plate fixing holes 24 and the bottom plate fixing holes 34 are space apart from each other at an interval of 90 degrees.

The fixing holes 24 and 34 are adopted to screw-couple and fix the spacer grid and a weld swivel plate with each other when the spacer grid is put on the weld swivel plate to conduct welding. (The weld swivel plate will be described later. Furthermore, for a simple description, the retention strap 10, the top plate 20 and the bottom plate 30 are generically called a spacer grid welding jig.).

FIG. 3 illustrates the weld swivel plate located inside a welding chamber of a general spacer grid welding device.

As shown in FIG. 3, the weld swivel plate located inside the welding chamber includes a first weld swivel plate 140 and a second weld swivel plate 150.

The first weld swivel plate 140 is a rectangular plate type, and has a rotation central axis, which is at a level with the ground and passes the center of the plate. (The rotation central axis is called a b-v axis, and it is shown as A in FIG. 3.)

The first weld swivel plate 140 includes; a rotation transmitter 144 mounted at an end of both ends thereof, through which the rotation central axis passes, and connected with a motor (not shown) for generating a rotational force on a rotary shaft of the first weld swivel plate 140; and a first weld swivel plate supporter 146 connected to the other end thereof for allowing a stable rotation of the first weld swivel plate when the first weld swivel plate rotates on the rotation central axis.

The second weld swivel plate 150 of a round form is mounted on the upper face of the first weld swivel plate 140.

The spacer grid to be welded is located on the upper face of the second weld swivel plate 150, and is rotated at a level with the first weld swivel plate 140 like a record disc since the rotation central axis passes through the center of the plate perpendicularly to the ground. (The rotation central axis of the second weld swivel plate 150 is called a c-w axis, and it is shown as B in FIG. 3.)

A laser welding part 200 is located above the welding chamber having the above welding device. The laser welding part 200 includes: an x-axis linear motion device 160 for conducting a lateral movement for welding; a y-axis linear motion device 170 for conducting a back and forth movement; and a z-axis linear motion device 180 for conducting a vertical movement. (See FIG. 4b)

However, such devices have the following problems.

As shown in FIG. 3, a portion of the spacer grid or the laser welding part can be moved and rotated in nearly all directions, but cannot be moved and rotated in a T-axis direction, which is shown in a dotted line.

In addition, cooling water flows into grid spaces of the spacer grid. However, since cooling water can provide better effect when it flows while forming a swirl, vanes 162 of a curved shape are formed on the grid spaces in such a way as to induce the swirl. (See FIG. 4a)

So, the laser beam must be transmitted not only vertically but also inclindely to weld the intersections of the vertical and horizontal grid plates of the spacer grid while avoiding the vanes 162. However, as described above, since the spacer grid or the laser welding part can be moved in various directions or rotated on various axes but cannot be rotated on the T-axis, the device has a problem in that it cannot provide a more exact and precise welding.

Furthermore, as shown in FIG. 4b, the laser welding part 200 according to the prior art reflects the laser beam by a mirror transmitting method, so that the laser beam arrives at the intersections of the grid plates. So the laser welding part 200 according to the prior art needs a laser beam supplier 202 mounted within a predetermined distance. In general, a laser beam supplier is mounted in the laser welding part and moved with the laser welding part during the x, y or z-axis linear motion. However, since the laser beam supplier 202 has the weight of 70 kg, the laser beam supplier 202 has a problem in that fatigability inside the laser welding part is increased by the weight of the laser beam supplier 202, and in that it is restricted in movement and rotation.

### SUMMARY OF THE INVENTION

Accordingly, the present invention has been made to solve the above-mentioned problems occurring in the prior arts, and it is an object of the present invention to provide a multi-axis laser welding head for a spacer grid, which can easily weld while avoiding welding obstructing parts, such as vanes, and allow a continuous welding on external inclined vanes since the laser welding head can be rotated on various axes when it welds intersections of grid plates of the spacer grid of the nuclear fuel assembly.

It is another object of the present invention to provide a multi-axis laser welding head for a spacer grid, which can make movement of a laser welding part easy and secure a supply of a laser beam since a laser beam supplier (oscillator) is separated from the laser welding head.

To accomplish the above object, according to the present invention, there is provided a multi-axis laser welding head for a spacer grid including: a main body;

an x-axis linear motion device located above the main body and formed in a rectangular parallelepiped, the x-axis linear motion device having an opened upper face thereof, a retaining jaw formed at the opened portion in parallel with a longitudinal direction thereof, an x-axis moving plate fit to the retaining jaw in such a way as to move laterally along the retaining jaw, and two y-axis rails formed on the upper surface thereof in a perpendicular direction to the retaining jaw and spaced apart from each other at a predetermined interval;

a y-axis linear motion device formed in a rectangular parallelepiped and located at right angles to the x-axis linear motion device, the y-axis linear motion device having the lower face fit to the y-axis rails of the x-axis linear motion device in such a way as to move back and forth, a support plate vertically formed at an end thereof in a longitudinal direction, and two z-axis rails 224 vertically formed on the support plate;

a z-axis linear motion device formed in a rectangular parallelepiped and having a longitudinal direction located perpendicularly to the y-axis linear motion device, so that a face of the z-axis linear motion device is fit to the z-axis rails in such a way as to move back and forth;

a laser welding head mounted on the lower end of the z-axis linear motion device; and

a condensing head mounted on a portion of the laser welding head in such a way as to rotate back and forth in regard to a line at right angles to the ground.

So, as described above, the multi-axis laser welding head for the spacer grid according to the present invention can easily weld while avoiding welding obstructing parts, such as vanes, and allow a continuous welding on external inclined vanes since the laser welding head can be rotated on various axes when it welds intersections of grid plates of the spacer grid of the nuclear fuel assembly.

In addition, the multi-axis laser welding head for the spacer grid according to the present invention can make movement of a laser welding part easy and secure a supply of a laser beam since a laser beam supplier (oscillator) is separated from the laser welding head.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a brief diagram of a general nuclear fuel assembly;

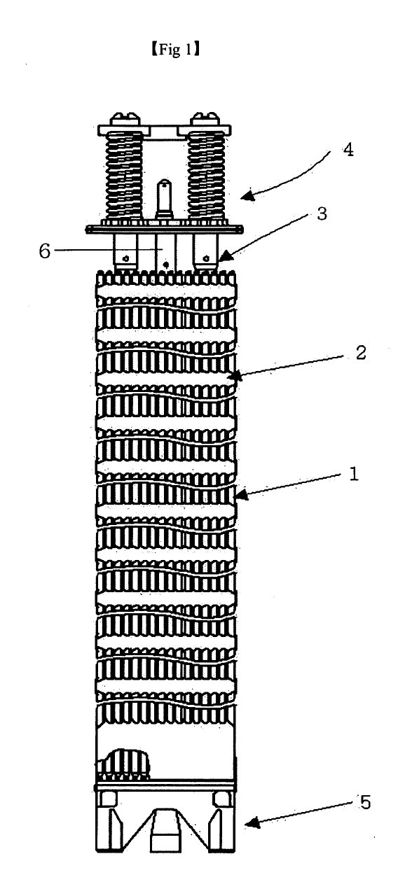

FIG. 2 is a brief diagram of a general device mounted on a spacer grid to weld the spacer grid before welding;

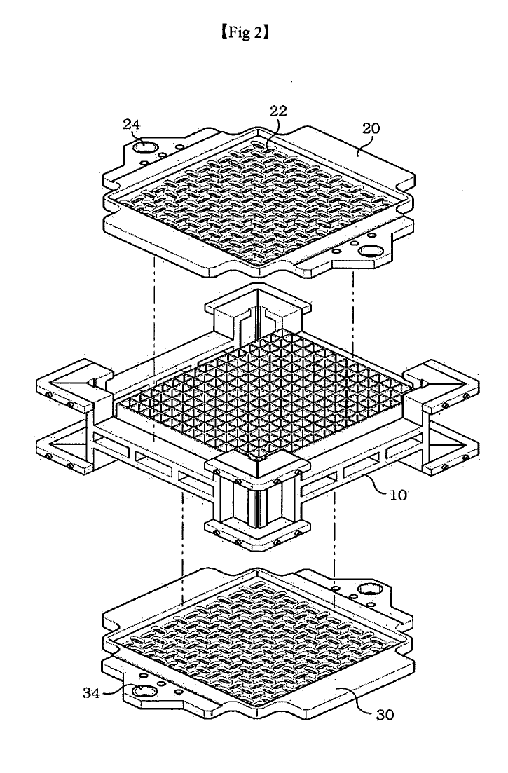

FIG. 3 is a perspective view of a general spacer grid welding swivel plate;

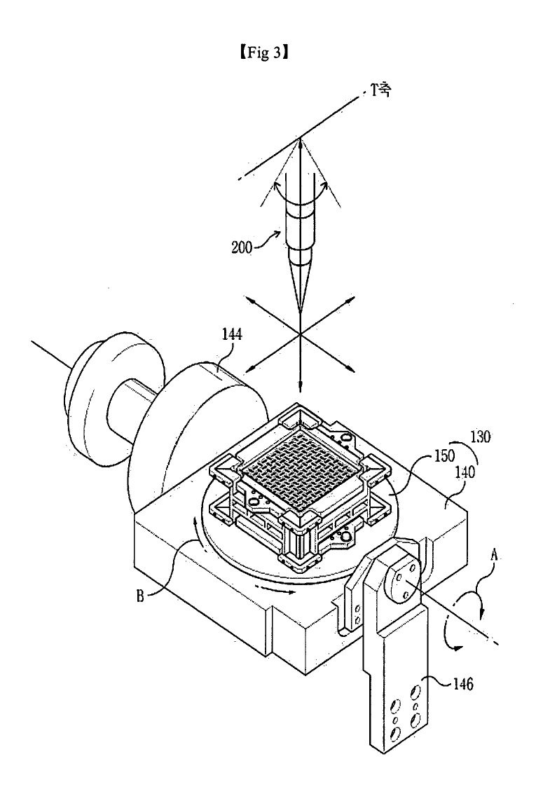

FIG. 4a is a view showing the upper face of the spacer grid;

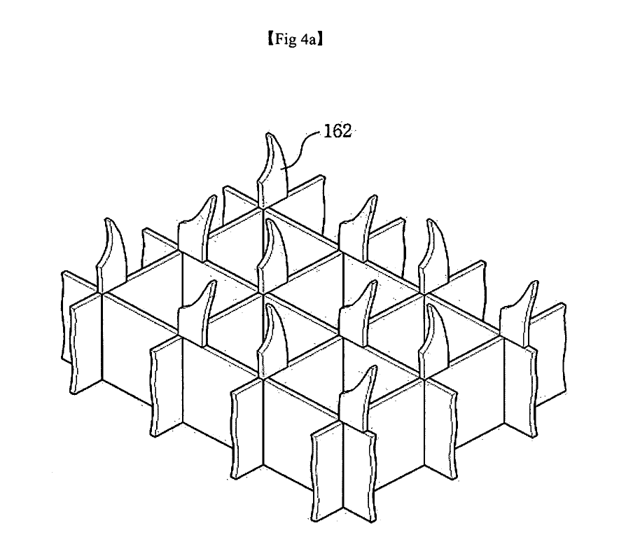

FIG. 4b is a brief diagram of a general laser welding part;

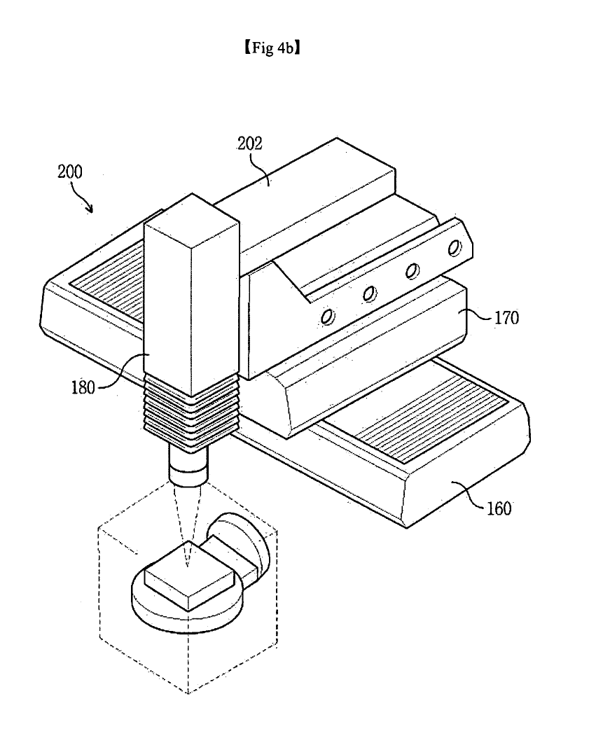

FIG. 5 is a perspective view of a laser welding part according to a preferred embodiment of the present invention;

FIG. 6 is a perspective view of a laser welding head according to the preferred embodiment of the present invention; and

FIG. 7 is a conceptual view of an optical fiber beam transmitting method applied to the present invention.

### DETAILED DESCRIPTION OF THE PREFERRED EMBODIMENT

Reference will be now made in detail to the preferred embodiment of the present invention with reference to the attached drawings.

A laser welding apparatus for a spacer grid according to a preferred embodiment of the present invention includes a main body (not shown) and a laser welding head moving device 200.

The main body (not shown) is a body of the laser welding apparatus for the spacer grid, and a welding chamber (not shown) and a laser welding part 200 are mounted on the main body. The mounted parts are controlled by the main body.

Since the main body (not shown) and the welding chamber (not shown) are the same as the prior arts, their descriptions will be omitted.

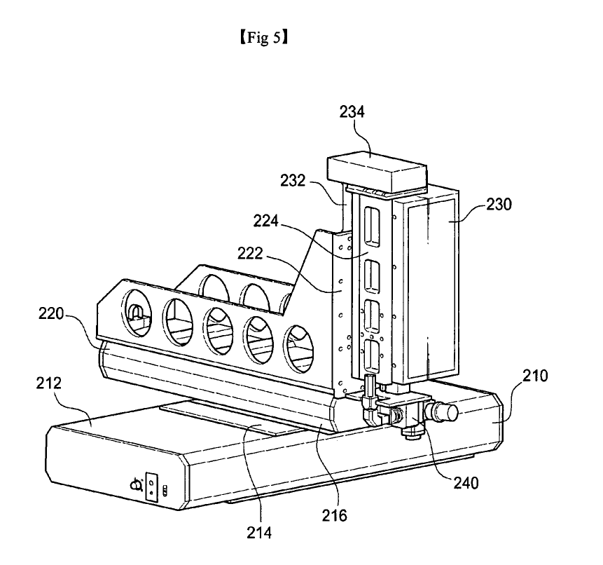

Referring to FIG. 5, the laser welding head moving device 200 will be described.

The laser welding head moving device 200 includes an x-axis linear motion device 210, a y-axis linear motion device 220, a z-axis linear motion device 230, and a laser welding head 240.

The x-axis linear motion device 210 is located above the main body (not shown), and is formed in a rectangular parallelepiped.

In addition, the upper face of the x-axis linear motion device 210 of the rectangular parallelepiped is opened, and has a retaining jaw 212 longitudinally formed at the opened portion thereof.

An x-axis moving plate 214 is fit to the retaining jaw 212, and laterally moved along the retaining jaw 212.

Moreover, two y-axis rails 216 are formed on the upper surface of the x-axis moving plate 214 at right angles to the retaining jaw 212 and spaced apart from each other at a predetermined interval.

The y-axis linear motion device 220 is formed in a rectangular parallelepiped, is at right angles to the x-axis linear motion device 210, and has the lower face fit to the y-axis rails 216 in such a way as to move back and forth.

The y-axis linear motion device 220 has a support plate 222 vertically formed at an end thereof in a longitudinal direction, and the support plate 222 has two z-axis rails 224 vertically formed thereon.

It is preferable that switch sensors for restricting the maximum travel distance to designate the maximum movement area of each axis are mounted on the x-axis and y-axis linear motion devices 210 and 220 for minutely adjusting a trip dog switch to thereby minutely adjust the maximum movable location.

The z-axis linear motion device 230 is formed in a rectangular parallelepiped, and its longitudinal direction is at right angles to the y-axis linear motion device 220, so that a face of the z-axis linear motion device 230 is fit to the z-axis rails 224 in such a way as to move back and forth.

In more detail, the z-axis linear motion device 230 has a z-axis servo-motor 232 mounted on the rear thereof and a timing belt 234 for connecting the z-axis linear motion device 230 and the servo-motor 232 with each other, whereby the z-axis linear motion device 230 can conduct a vertical movement.

In addition, it is preferable that the z-axis servo-motor 232 has a brake therein to prevent that z-axis linear motion device 230 does not slide by its self-weight.

Next, the laser welding head 240 will be described.

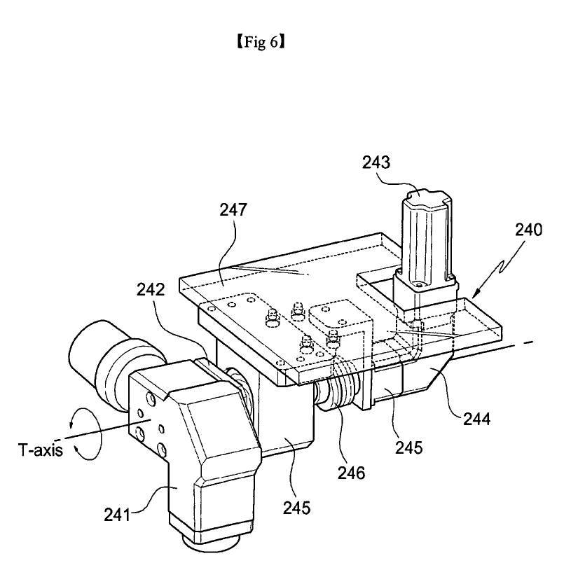

The laser welding head 240 is located below the z-axis linear motion device 230 to emit a laser beam to the spacer grid (not shown), and is illustrated in FIG. 6 in more detail. Referring to FIG. 6, the laser welding head 240 includes a condensing head 241, a bearing housing 242, a condensing head servo-motor 243, and a bevel reduction gear 244.

First, the condensing head 241 will be described.

The condensing head 241 is in a [symbol] form and fixed at the center thereof, and can conduct a circular motion on an axis of the fixed portion. An end of the condensing head 241 emits the laser beam, and the other end receives the laser beam.

The portion to receive the laser beam is made of optical fiber, and connected with a laser beam supplier (not shown), to thereby receive the laser beam from the laser beam supplier through an optical fiber beam transmitting method.

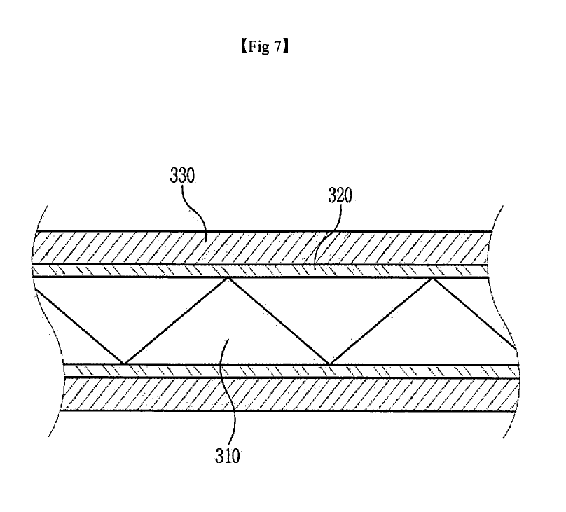

The optical fiber beam transmitting method uses the total reflection principle. Referring to FIG. 7, since a medium of a high refractive index is located at the center and covered with a medium of a low refractive index, an incident light of a low angle continuously generates the total reflection between a core 310 and a cladding 320 to thereby continuously transmit the laser beam. The outermost portion is coated with sheath 330 to thereby protect the inside.

In addition, since the optical fiber is mounted at a side of the condensing head 241 to weld the spacer grid located inside the welding chamber (not shown) located below the condensing head 241, the condensing head 241 conducts a back and forth rotating motion on a line perpendicular to the ground rather than a circular motion. That is, the condensing head 241 conducts a T-axis rotating motion.

The condensing head 241 and a condensing head inclined shaft (not shown) are connected with each other by a bearing, and the bearing is surrounded by the bearing housing 242.

The condensing head inclined shaft (not shown) is connected with the condensing head servo-motor 243 by the bevel reduction gear 244. Furthermore, a bracket 245 and a coupling 246 serving to connect brackets with each other and connect shafts with each other are connected between the bearing housing 242 and the bevel reduction gear 243. In addition, a fixed head 247 is provided to fix the above components and connect the condensing head to the z-axis linear motion device 230.

The fixed head 247 is located below the z-axis linear motion device 230 (see FIG. 5), and the bracket 245, the bevel reduction gear 244, the bearing housing 242 and so on are mounted on the bottom of the fixed head 247.

Actions and effects of the present invention having the above configuration will be described.

When the spacer grid of the nuclear fuel assembly is welded, since the spacer grid can conduct the x-axis, y-axis and z-axis motions and the condensing head can conduct the T-axis motion by the condensing head servo-motor 243 and the bevel reduction gear 244, the present invention can remove the difficulty in welding caused by the vanes formed on the spacer grid of the prior art. Moreover, the present invention can reduce fatigability of the laser welding head and make the movement and rotation of the laser welding head easy since the laser beam supplier (oscillator) is not put on the y-axis linear motion device 220 by virtue of the optical fiber laser transmitting method using the total reflection.

While the present invention has been described with reference to the particular illustrative embodiment, it is not to be restricted by the embodiment but only by the appended claims. It is to be appreciated that those skilled in the art can change or modify the embodiment without departing from the scope and spirit of the present invention.

What is claimed is:

1. A multi-axis laser welding head for a spacer grid, which includes a laser beam supplier located above a main body of a welding apparatus for supplying a laser beam, an x-axis linear motion device, a y-axis linear motion device, a z-axis linear motion device, and a condensing head mounted on the z-axis linear motion device, wherein the condensing head is rotatable about any one of an x-axis, a y-axis and a z-axis.

2. The multi-axis laser welding head for the spacer grid according to claim 1, wherein, the condensing head and the laser beam supplier are connected with each other via an optical fiber.
